(19) United States
(12) Patent Application Publication
(10) Pub. No.: US 2008/0222963 A1
(43) Pub. Date: Sep. 18, 2008

(54) Door Comprising an Identification Unit and an Electrical Lock and Door Body For Use In Such a Door

(75) Inventor: Hans Nicolaas Zwart, Leidschendam (NL)

Correspondence Address: HOFFMANN & BARON, LLP, 6900 JERICHO TURNPIKE, SYOSSET, NY, 11791, US

(73) Assignee: SIOS CONCEPTS B.V.

(21) Appl. No.: 11/997,639

(22) PCT Filed: Mar. 31, 2006
(86) PCT No.: PCT/NL2006/000166

§ 371 Date: Feb. 21, 2008

(30) Foreign Application Priority Data
Apr. 1, 2005 (NL) 1028680

(51) Int. Cl. E06B 5/00; G07C 9/00; E05B 47/00

(52) U.S. Cl. 49/503; 70/277

(57) ABSTRACT

A door comprises an identification unit for the identifying of a person or object situated in the vicinity of the door The identification unit provides an unlocking signal when an identification of the person or the object satisfies a predetermined criterion. The door also comprises an electrical lock for the unlocking of the door in response to the unlocking signal. The identification unit and the electrical lock are built into the door, according to the invention, for example, in the form of an insert unit that can be arranged in a cavity of the door from an end side of the door. The door can furthermore contain a communication unit for the sending and receiving of messages and a power supply unit for energizing the identification unit, the electrical lock, and the communication unit. By placing the above-mentioned components in the door, a considerable reduction in installation time can be achieved, since the laying of wiring in the vicinity of the door can be omitted to a substantial degree.

The invention pertains to a door comprising an identification unit and an electrical lock. The invention also pertains to a door body for use in such a door.

It is known how to mount an access lock on doors of offices, nursing and care homes, hospitals, hotels or other public buildings. Usually, an identification unit such as a reader for a magnetic pass, chip pass, or a reader of a wireless transponder is placed in the vicinity of the door, for example, on a door casing, or on a wall near the respective door. When a user identifies himself at the door with a suitable means of identification, such as a chip card, magnetic card, or the like, the identification unit will provide a suitable signal to the electrical lock, by which the door is unlocked. The electrical lock is normally placed in a door jamb.

A problem of the above-described identification unit and electrical lock is that the installing thereof is complicated. First of all, a large quantity of wiring needs to be laid, namely, a wiring to the identification unit (for example, a network cable so as to operate the identification unit at a distance), and then an electrical connection of the identification unit to the electrical lock for purposes of the sending of a signal to the electrical lock, an electrical wiring of the electrical lock, including for example the just mentioned wiring from the identification unit to the lock and, for example, an electrical power supply for the lock. An electrical power supply for the identification unit can also be provided. All in all, this means that a large number of electrical conductors need to be laid in the vicinity of the door. For aesthetic reasons and in order to hinder any fraud or fraudulent disabling of the electrical lock and/or the identification unit, the wiring is usually concealed, for example, in a wall located around the door. Such a concealment can mean, for example, that several grooves need to be cut in the wall, after which cable conductors and wiring need to be laid therein, after which the grooves need to be sealed and the wall in its entirety usually needs to be provided with a new finish coat, such as a paint coat or wall paper. The identification unit and the electrical lock also each need to be mounted, which likewise can lead to extra work, such as drilling, cutting, demolishing, etc. Another factor at play here is that the identification unit and the electrical lock need to be placed such as to hinder a forcing or other kind of fraudulent manipulation as much as possible.

One goal of the invention is to install intelligence, such as but not confined to an identification and access system, in a building in an advantageous manner.

To accomplish this goal, the door according to the invention comprises
an identification unit for the identifying of a person or object situated in the vicinity of the door and the creating of an unlocking signal when an identification of the person or the object satisfies a predetermined criterion; and
an electrical lock for the unlocking of the door in response to the unlocking signal,
   wherein the identification unit and the electrical lock are built into the door,
   wherein the door has a cavity which is open toward one end side,
   wherein an insert unit containing at least one of the identification unit, the electrical lock, the power supply unit, and a communication unit is arranged in the cavity, while the door has at least one additional cavity, in which is arranged another insert unit containing at least one of the identification unit, the electrical lock, the power supply unit and the communication unit, while the cavity is made in one end side away from the hinge of the door, and the other cavity is made in an end side of the door facing the hinge.

Since components such as the identification unit, the power supply, and the electrical lock are built into the door, no wiring has to be laid around the door, and no additional units need to be installed around the door, which considerably reduces the installation time. The components such as the identification unit, the power supply and the electrical lock can be installed in the door on site, but it is also possible for these to be arranged in the door already during the fabrication of the door or by an installer, so that a number of steps needing to be performed on site can be diminished. For a simple electrical connection, the door can be provided with a cable lead-through between the cavity and the additional cavity, or it can have preassembled cables in place. Additional benefits and preferred embodiments of the door will be made clear by means of the following-description of drawings. It is also possible to omit the identification unit from the door, for example, for a door which is unlocked remotely.

The door body according to the invention for use in a door according to the invention has a cavity which is open toward one end side for arranging therein an insert unit containing at least one of the identification unit, the electrical lock, the power supply unit, and a communication unit, while the door has at least one additional cavity for the arranging therein of an additional insert unit containing at least one of the identification unit, the electrical lock, the power supply unit and the communication unit, while the cavity is made in one end side away from the hinge of the door, and the other cavity is made in an end side of the door facing the hinge.

Since the wiring is already arranged in the door, there is a considerable saving on installation time and expense, inasmuch as no cables need to be laid in the vicinity of the door in order to connect, for example, the identification unit to the electrical lock. Thanks to the cavities which are present in the door body, modules or insert units such as the identification unit and the electrical lock can be easily accommodated therein. A further benefit is that the units such as the identification unit and the lock are safely arranged, since they are taken up in the door and thus are protected by the door. Likewise, an aesthetically attractive whole is achieved in simple manner, since the units such as the identification unit and the electrical lock by being accommodated in the one or more cavities are at least partially hidden from view. By a door body in the context of this application is meant, furthermore, a door panel or leaf, in other words, a flat or a primarily flat element for mounting in a door opening, door casing, or the like, so as to close the door opening, casing, or the like in the closed condition, and in the opened condition to provide a passageway through the door opening, casing or the like. The door body can be made from any desired material, such as wood, metal, glass or any other material, or combination of materials, including fireproof materials, soundproofing materials, finish layers, etc., and can have any desired thickness and any desired dimension. The benefits which are mentioned here with respect to the door panel per the invention are likewise applicable to the door per the invention and a preferred embodiment thereof.

Further preferred embodiments, benefits, characteristics and properties of the invention will become clear by means of the accompanying drawing, which shows nonlimiting sample embodiments of the invention:

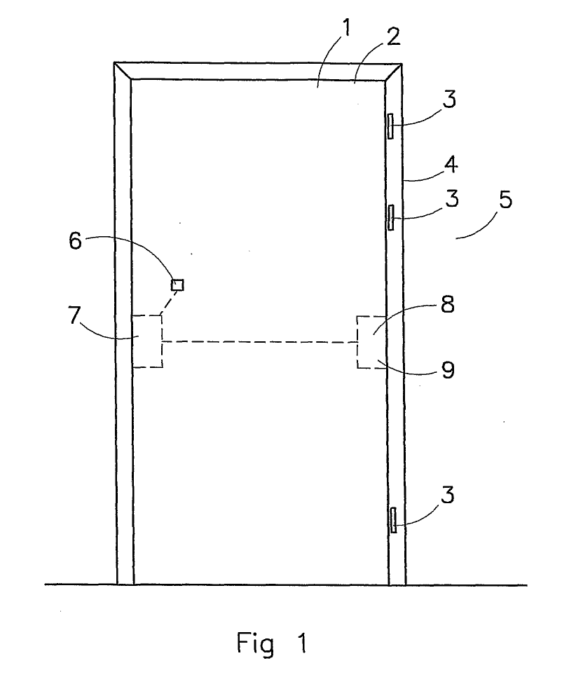

FIG. 1 shows a schematic side view of a door according to one embodiment of the invention;

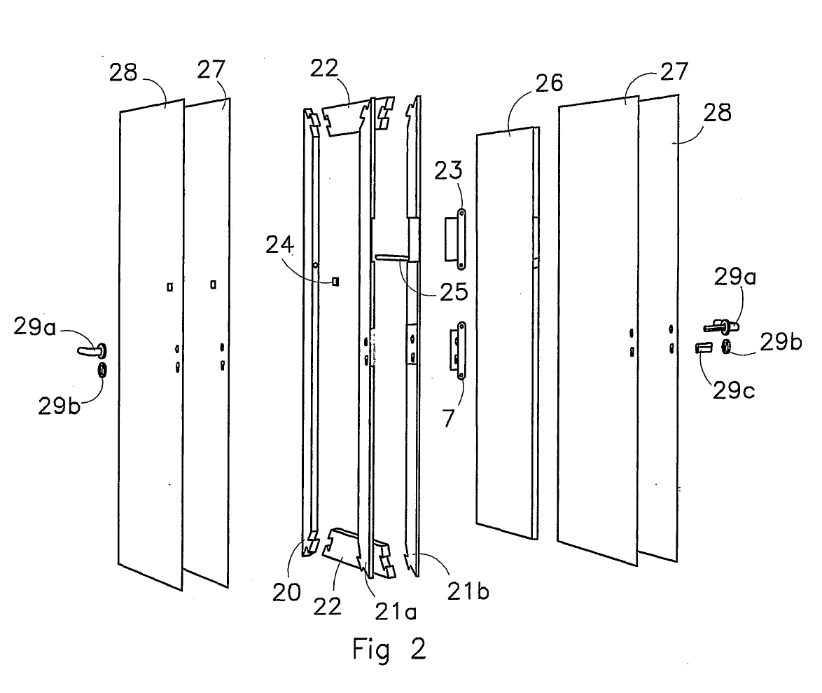

FIG. 2 shows an exploded view of one embodiment of a door according to the invention;

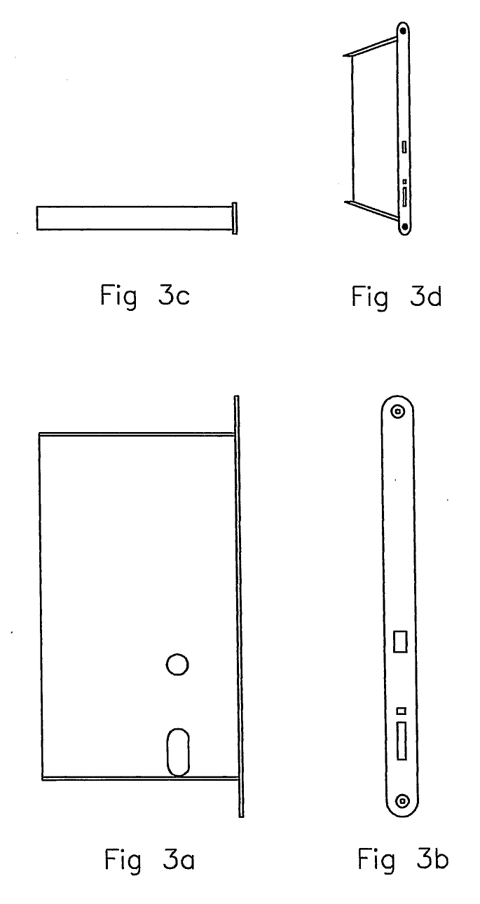

FIG. 3 shows one embodiment of an insert unit for one embodiment of a door according to the invention;

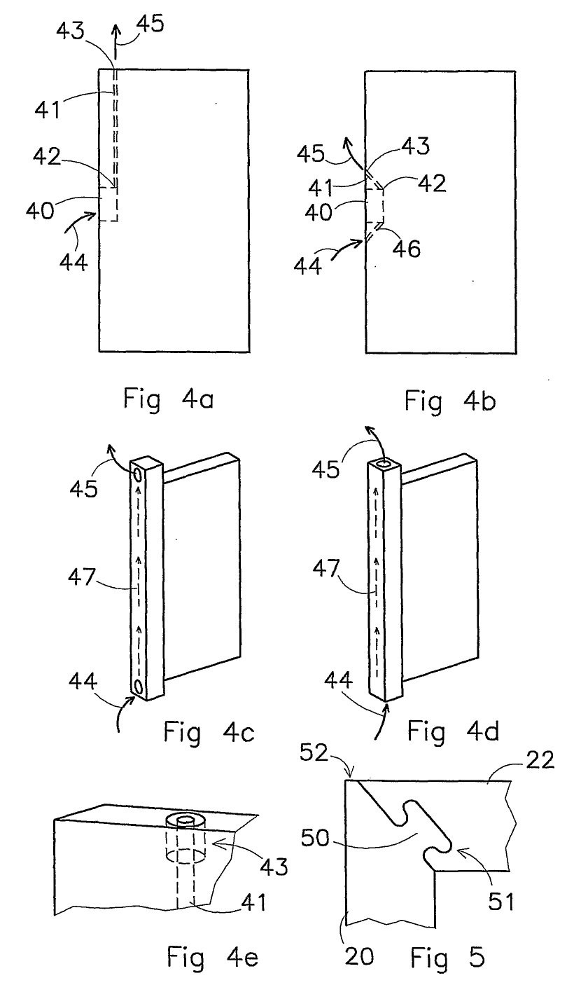

FIGS. 4a-e show detail embodiments of a heat dissipation of doors according to one embodiment of the invention; and

FIG. 5 shows a detail front view of part of a longitudinal element and part of a transverse element of a door according to one embodiment of the invention.

FIG. 1 shows in schematic fashion a side view of a door 1 comprising a door body 2. The door body 2, also known as a door leaf or a door in short, is joined by hinges 3 or any suitable connection to a door jamb 4, which is arranged, for example, in a wall 5. The door 2 comprises an identification unit 6 for the identifying of a person or object situated in the vicinity of the door. The door likewise contains a lock 7, such as an electrical lock. Between the identification and the electrical lock in this sample embodiment there is present an electrical connection. The electrical lock is designed to unlock the door in response to an unlocking signal that is generated by the identification unit in the case that an identification of the person or object satisfies a predetermined criterion. The identification unit 6 and the electrical lock are built into the door, as shall be explained further below. The identification unit can contain, for example, a reader for reading of a chip card or a magnetic pass, a wireless transceiver for the reading of a so-called transponder or other wireless identification, a biometric identification unit such as an iris scanner, a blood vessel scanner for scanning the blood vessel pattern of a body part, such as the hand, a camera for detecting an infrared scan, a camera for detecting a visual facial scan, a voice recognition, a fingerprint scanner, etc. It is possible for the identification unit 6 to form a separate module that is separately built into the door, but it is also possible for the identification unit 6 to be connected to the lock 7, being an integral part thereof, or not.

FIG. 1, moreover, shows a power supply unit built into the door for energizing the identification unit 6 and the lock 7 in this sample embodiment. Between the power supply unit 8 and the lock 7 there is an electrical connection (shown by broken line in FIG. 1) for the transfer of electricity from the power supply unit 8 to the lock 7. Likewise, a connection can be provided to the identification unit for the energizing thereof. The power supply unit 8, moreover, can energize other units in the door, examples of which will be given below. The power supply unit 8 in this sample embodiment is arranged at the side of the door 2 turned toward the hinges 3. One benefit of this is that the connection between the power supply unit (which is located in the movable door) and the casing 4, which is stationary relative to the door, can be short: thus, for example, one can make use of an induction hinge for the no-contact, i.e., wireless supply of electricity to the power supply unit. It is also possible for the power supply unit to be connected by means of a conductor, such as an electricity cable, to an electrical junction in the doorcasing or in the wall.

The door can likewise contain a communication unit 9 for the sending and/or receiving of a message. The communication unit can be connected, for example, to the identification unit and/or the lock to relay the message. The communication unit makes it possible to send and/or receive information by one or more of the identification unit, the electrical lock, the power supply unit, etc. One advantage is that data from the door can be transferred to a central information processing unit, for example, the lock or the identification unit would be able to send data on the persons and/or objects having identified themselves at the door, or data could be sent from the central processing unit to the door, for example, in order to provide an authorization for persons and/or objects to gain access via the door, in other words, the providing of information to the identification unit , whether or not to produce an unlocking signal for the electrical lock in response to an identification by a particular person and/or object. The communication unit can contain, for example, a wireless communication unit, such as a radio frequency transceiver or an optical transceiver, so that a wireless communication is possible, being an improvement on the laying of wiring. It is also possible, in an advantageous embodiment, for the communication unit to be designed for communication via a lighting circuit. Or some other conductor for purposes of providing an electrical power supply to the power supply unit. This is particularly advantageous in that no further wiring is required for the communication in these preferred embodiments, since the communication now occurs via an electrical connection that may be present in any case, namely, a lighting circuit or other electrical conductors for the energizing of, say, the power supply unit. Furthermore, it is possible for the communication unit to have a network connection for communicating with a data network, which is especially advantageous when a number of doors, such as a large number, provided with such a communication unit are arranged in a building or other construction and all of them need to be actuated and/or operated, say, from a central processing unit.

As shall be further explained in detail, the door in this sample embodiment has two cavities, which are open at one end side. In one of the cavities is arranged the electrical lock 7, and in the other cavity is arranged the power supply unit 8 and the communication unit 9. For this, the electrical lock is accommodated in an insert unit, which can be arranged in the cavity from the end side of the door. In similar manner, the power supply unit with the communication unit is accommodated in an insert unit, which can likewise be placed therein from one end side (also called an end surface) of the door. From FIG. 1, it will be clear to the practitioner that the electrical lock can be inserted from an end surface which is opposite the edge of the door where the hinges 3 are arranged, while the power supply unit and the communication unit can be arranged in a cavity that emerges at the end side of the door located at the side of the door where the hinges 3 are mounted. The door, furthermore, can have cavities in any desired location, besides or in place of the cavities shown here.

FIG. 2 shows a layout of one embodiment of the invention in exploded view and reveals a longitudinal element 20 and longitudinal elements 21a and 21b which together form a longitudinal element 21. FIG. 2 also shows transverse elements 22 for joining together the longitudinal elements 20, 21. The longitudinal and transverse elements together form a structure which provides stability to the door. A connection between the longitudinal elements and transverse elements shall be explained by means of FIG. 5. The longitudinal elements and transverse elements can be made, for example, from plywood. In the sample embodiment shown in FIG. 2, the longitudinal element 21 contains a pair of cavities, namely, one cavity for placing the electrical lock 7 therein and one cavity for placing electronics 23 therein, for example, a processing unit for processing of a signal that is furnished by a sensor 24. The sensor 24 and the electronics 23 together form an identification unit 6, such as the identification unit 6 from FIG. 1. Since the longitudinal element 21 is made from sections 21a, 21b, the cavities can be easily made therein by making a notch in the elements 21a, 21b, as shown in FIG. 2. A space enclosed by the longitudinal and transverse elements in the sample embodiment shown here is filled with a foam, such as Phenol foam, for example, that known as Ecophen. Of course, any other foam can likewise be used; but an advantage of Phenol foam is that this offers a better shape stability, which provides extra mechanical strength to the door, it can be obtained in a great variety of standard thicknesses, and it provides reliable fire-retardant properties in that the foam is carbonized at high temperature and does not catch fire. A further benefit is that the foam is sound-absorbing and has sufficiently high density to make screw connections in it. It is also possible to mill the foam, for example, so as to make air ducts or screw connections or cable conduits or cavities in it to accommodate the insert unit or other insert units. One example of a cable conduit or cable lead-through is shown in FIG. 2 and indicated as 25. The foam in this sample embodiment is shown shaped into a sheet and indicated as 26. The door as depicted in FIG. 2 also contains a pair of panels (for example, made from plywood), which cover (or, for example, partly cover) the assemblage of the longitudinal elements and the transverse elements on either side. The panels, which are indicated by 27 in FIG. 2, are covered on one exposed side by a finish layer, such as a high-pressure laminate 28. FIG. 2, moreover, shows a door latch 29a, rosette 29b, and lock cylinder 29c. One benefit of the panels is that these provide a mechanical rigidity to the door and furthermore offer an extra protection to insert elements such as the electrical lock or the electronics, so as to prevent unauthorized parties from gaining access through the door simply by violent measures. In the panel and the high-pressure laminate an opening is made, in this sample embodiment at one side, but of course it is also possible for such an opening to be present on both sides of the door, or for a sensor to be arranged on both sides of the door, by which identification of the person can take place via the sensor on the respective side of the door.

FIG. 3 shows different views of an insert unit, such as the lock 7 or the power supply unit 8 or communication unit 9 from FIG. 1, the lock 7 from FIG. 2, or the electronics 23 from FIG. 2. Thus, FIG. 3a shows a side view of the insert unit, wherein openings have been made in this sample embodiment to accommodate a door latch and a lock cylinder. In the event, however, that the insert unit is used for a different purpose, such as a power supply unit or communication unit, such openings do not necessarily have to be present. A view of the end side of the door is shown in FIG. 3b, a top view in FIG. 3c, and a perspective view in FIG. 3d. The insert unit can be provided with an enclosure made of metal, such as stainless steel, being a plate or a perforated plate. One advantage of this is that mechanical protection is afforded to the electronics or electronic components accommodated in the insert unit and that a protection against electromagnetic interference, such as radiation from mobile telephones or interference from mobile telephones, can be omitted to a large extent. It is also pointed out that the perspective view of FIG. 3d shows a partly removed insert unit, in which a portion of the enclosure has been taken away. The enclosure can also be made in whole or in part of a different material than the metal mentioned here, for example, of plastic. Preferably, the insert units that are placed in the door, such as the door per FIG. 1 or per FIG. 2, all have the same dimensions, so that a standardized installation possibility is provided for the installing of a variety of electronic modules in the door.

The one or more cavities of the door can contain conduits for the leading in of the insert unit from the end side of the door. This enables a simple, fast and stable installation of the insert unit. Furthermore, it is possible for the cavity to have an opening to an outer surface of the door (for example, an opening can be provided from the cavity to the outer surface of the door for purposes of an identification unit). Thus, for example, the identification unit 6, which is shown in FIGS. 1 and 2 as a separate element, can be accommodated in the lock 7. An opening for the identification unit 6, as shown in FIGS. 1 and 2, where these openings provide a passage to an outer surface of the door, will in the instance described here emerge into the cavity or into one of the cavities of the door for purposes of the one or more insert units. For purposes of a good identification, it is desirable that the identification unit (or anyway a sensor thereof) lie close against an outer surface of the door. When inserting said insert unit from an end side of the door, this might then lead to a clamping or jamming, or a situation in which the sensor, accommodated in the insert unit, lies relatively deep with respect to an outer surface of the door when the insert unit is shoved into the door. One way of remedying this problem is to provide the conduit with a bend so that, when the insert unit is inserted into the cavity, it is translated in a direction toward the surface of the door, so that a portion of the insert unit (containing, for example, the sensor or identification unit) is brought toward the surface of the door. An alternative to the solution mentioned here is to provide the insert unit with a spring-loaded section, while the spring-loaded section contains the sensor or the identification unit, for example, so that when the insert unit is inserted into the cavity the spring-loaded section springs outward into the opening. When removing the insert unit, the spring-loaded section can then, for example, be forced inward from the outside, while at the same time the insert unit is moved outward from the end side of the door.

FIG. 4a shows in schematic fashion a view of a door, in which a cavity has been made, in which an electrical lock 7, for example, is arranged in this sample embodiment. However, the principles explained by means of FIG. 4a-4d are not exclusively applicable to the electrical lock, but can be adopted in combination with any given insert unit (such as the power supply unit). In the sample embodiment shown in FIG. 4a, from the cavity, here indicated as 40, a channel 41 is arranged, emerging at one end 42 in the cavity 40 and at its other end 43 it emerges at an end face of the door. In the embodiment shown in FIG. 4a, the end of the channel that emerges at the end face of the door is situated at the top of the door. In the variant shown in FIG. 4b, this end is situated not at the top of the door, but at a side edge. The channel 41 as depicted in FIG. 4a and FIG. 4b provides for a removal of heat from electronic or electric components that are located in the insert unit arranged in the cavity 40. For this, it is possible, for example, that the insert unit is provided with an opening (not shown) or that, as shown in FIG. 4b, a second channel 46 is present, which also emerges, for example, at an end side of the door. In both cases, the heat produced in the insert unit will cause an air flow, indicating the inflow of arrow by arrow 44 and the outflow of air by arrow 45. Of course, many variants are conceivable for the embodiments shown in FIGS. 4a and 4b. Thus, for example, in FIG. 4a, an intake of air can occur, via a channel 46, as is shown in FIG. 4b, an inflow could occur via an opening between the insert unit and one wall of the cavity, etc. It is also possible for inflow of air to occur via a channel that emerges at the bottom of the door or in a keyhole. It is likewise conceivable for the channel 41 instead of or in addition to the embodiments shown in FIGS. 4a and 4b will emerge into an opening to an outer surface of the door, in which for example a sensor of an identification unit or an identification unit is arranged, and an opening is present between one wall of the channel and the sensor or identification unit for purposes of an air flow. FIG. 4c shows an alternative to the cooling channels described by means of FIGS. 4a and 4b. FIG. 4c shows an insert unit, for example, a lock 7, a power supply unit 81 communication unit 9, etc., which is provided with a channel 47 at one side, which is turned toward the end face of the door in the installed condition. Inflow of air, as is schematically shown by arrow 44, can occur via an opening located at the bottom of the insert unit, and outflow of air, as schematically indicated by arrow 45, can occur via an opening located at the top of the insert unit. Inflow 44 and outflow 45 of air occurs here at the end face of the door. By means of an air flow that occurs in the channel 47 from inflow 44 to outflow 45, a cooling effect can be achieved. The cooling effect can be further strengthened by providing the insert unit with a cooling body, while the channel 47 is in connection with the cooling body. Air flowing into the channel will thus flow along at least a portion of the cooling body and thereby produce a certain degree of cooling thereof. In another embodiment, instead of or in addition to the sample embodiments described by means of FIGS. 4a-4c, it is possible for the insert unit to be provided with a cooling profile at the side which is turned toward the end face of the door in the installed condition. The cooling profile can contain, for example, cooling fins or any other desired shape to achieve a low thermal resistance between the cooling profile and the air flowing past it. The channel 47 as shown in FIG. 4c can also, of course, emerge into an opening that is located between the insert element and a wall of the cavity, as represented schematically in FIG. 4d. In order to close off the channel in event of a fire or other effect of heat and thereby satisfy requirements, such as legal requirements, in regard to fire safety, the channel in the embodiments as described by means of FIGS. 4a-4d can be encased for at least part of its length, entirely or partly by a material that expands upon rise in temperature. By expansion of material, this will completely or partly seal the channel along the segment of length whenever a rise in temperature occurs, such as due to fire, etc. Preferably, the material or in other words the segment of length is arranged at the end or one of the ends of the channel that emerges at the end face of the door. One advantage of this is that a rapid response occurs, since in the event of an increase of surrounding temperature this will not quickly lead to a heating of a material that is situated near one end of the channel that emerges outside of the door, for example, at the end face of the door. The material can have, for example, an annular shape, with the ring enclosing the channel for a portion of its length, so that when the material expands due to a temperature rise a relative closure of the channel occurs.

FIG. 5 shows part of a longitudinal element 20 and part of a transverse element 22 joined to the longitudinal element 20. The longitudinal element and the transverse element are joined together by means of a piece 50 of the longitudinal element and a piece 51 of the transverse element, the pieces being complementary to each other in shape. In this sample embodiment, the piece 50 of the longitudinal element contains a bulge, while the piece 51 of the transverse element contains an indentation that is complementary to the bulge. The complementary piece of the longitudinal element is present only along a portion of the longitudinal element, looking in a direction of the door which is parallel to the transverse element, namely, an outer piece 52 of the longitudinal element is not provided with a complementary piece in this sample embodiment. This means that an assembly of longitudinal elements and transverse elements looking in the direction parallel to the transverse elements consists of the longitudinal elements in an outer region of the door. This means that the door can be planed off, sawn off, etc., on a long side without sacrificing mechanical strength, and the material will be removed from the portion 52 of the longitudinal element. One advantage of this is that some degree of planing, sawing, or otherwise reducing the width of the door does not lead to a significant weakening of its sturdiness, since only the part 52 of the longitudinal element 20 will be sawn off, planed off, etc., and a joint between the longitudinal element 20 and the transverse element 22 formed by the complementary parts will not be affected by this. Although this embodiment as described here is for a decrease in width by providing the piece 52 of the longitudinal element 20, this same principle of course can also be applied to the longitudinal element so as to reduce to some extent the height of the door, without affecting its sturdiness to a large degree.

With the door as described by means of the above sample embodiments, it is possible to achieve a fast and simple implementation of intelligent access and security technology, since a minimum of installation and wiring is necessary on site. In the same embodiment as described, for example, by means of FIG. 1, it is only necessary to provide a lighting circuit or other power supply connection to the door. In view of the fact that lighting circuit connections are plentiful in buildings and other constructions, one can make do with a minimal quantity of installation operations on site. Mounting the various units such as the lock, the identification unit, power supply unit, etc., in the door can save a considerable amount of installation time, as compared to solutions as chosen from the prior art.

Of course, it is also possible that the door besides or in place of one or more of the above-described insert units will have at least one or more additional electric units inserted or built into the door, such as a proximity detector (for purposes of an alarm system or proximity detection), a smoke detector (for purposes of a fire alarm or other disasters), a breath detector (for purposes of a personal monitoring, as in a hospital or care facility), a lighting unit such as a light emitting diode LED, and a monitor screen, such as a liquid crystal display LCD or a plasma screen.

With the door according to the invention, many advantageous applications can be realized: thus, for example, by means of an identification of a user, it is possible to adapt an office space to the user, for example, in the case of a flexible work station one can adapt computer, telephone system, lighting and heating to their needs, for example, by switching through the telephone number of the particular person to the room where the person has identified himself, by granting network use rights for the particular person to the computer located in the respective room, etc. In the event that a LCD screen is present in the door, various information can be presented on it, such as the presence or reservation by the user; in the event of fire or other disaster, messages such as escape routes can be indicated. In the event of a hotel application, for example, a welcome message, reservation times, “do not disturb” or room cleaning messages, etc., can be presented on such a LCD screen. Also in that instance personal preferences for the room can be adjusted, for example, whenever a user identifies himself at the door, by adjusting the heating, radio or telephone channels, lighting, etc., to their specific wishes or personal settings. Telephone conversations in this case can also be switched directly through to the telephone set in the particular room.

1. Door, comprising:
an identification unit for the identifying of a person or object situated in the vicinity of the door and the creating of an unlocking signal when an identification of the person or the object satisfies a predetermined criterion; and
an electrical lock for the unlocking of the door in response to the unlocking signal,
wherein the identification unit and the electrical lock are built into the door,
wherein the door has a cavity which is open toward one end side, and
wherein an insert unit containing at least one of the identification unit, the electrical lock, the power supply unit, and a communication unit is arranged in the cavity, while the door has at least one additional cavity, in which is arranged another insert unit containing at least one of the identification unit, the electrical lock, the power supply unit and the communication unit, while the cavity is made in one end side away from the hinge of the door, and the other cavity is made in an end side of the door facing the hinge.

2. Door according to claim 1, further comprising cable lead-through extending from the cavity to the additional cavity.

3. Door according to claim 1, wherein the door has a channel that emerges at one end into the cavity and at the other end it emerges at an end face of the door.

4. Door according to claim 3, wherein the channel for a portion of its length is at least partly encased by a material that expands upon rise in the temperature.

5. Door according to claim 4, wherein the portion of the length is located near the end of the channel that emerges at the end face of the door.

6. Door according to claim 3, wherein the end of the channel that emerges at the end face of the door is located at the top of the door.

7. Door according to claim 1, wherein the insert unit is provided with a cooling profile at its side that is facing the end face of the door in the installed condition.

8. Door according to claim 1, wherein the insert unit is provided with a channel at one of its sides that in the installed condition is turned toward the end face of the door, emerging at both of its ends at the side which is turned toward the end face of the door in the installed condition.

9. Door according to claim 3, wherein the insert unit has a cooling body and the channel is in communication with the cooling body.

10. Door according to one of claim 3, wherein the channel for a portion of its length is at least partly encased in material that expands upon rise in temperature.

11. Door according to claim 1, containing the communication unit for sending and/or receiving of a message, wherein the communication unit is connected to at least one of the identification unit and the lock for the transmission of the message.

12 Door according to claim 11, wherein communication unit is designed to communicate by a lighting circuit.

13. Door according to claim 11, wherein the communication unit comprises a radio frequency or optical transceiver for wireless communications.

14. Door according to claim 11, wherein the communication unit has a network connection for communicating with a data network.

15. Door according to claim 1, wherein the door contains the power supply unit for the energizing of at least the identification unit and the lock.

16. Door according to claim 15, wherein the power supply unit contains an induction hinge for the no-contact supplying of electric energy to the power supply unit.

17. Door according to claim 1, wherein the insert unit comprises the electrical lock and wherein the additional insert unit comprises the power supply unit.

18. Door according to claim 1, wherein the cavity and/or the additional cavity contain conduits for leading in the insert unit from the end side of the door.

19. Door according to claim 1, wherein the cavity contains an opening to an outer surface of the door and wherein the conduit has a bend for translating the insert unit in a direction toward one surface of the door when inserting the insert unit into the cavity, for leading a portion of the insert unit into the opening.

20. Door according to claim 1, wherein the cavity has the opening toward the outer surface of the door and wherein the insert unit contains a spring-loaded piece for springing this piece into the opening when inserting the insert unit into the cavity.

21. Door according to claim 20, wherein the spring-loaded piece comprises at least a portion of the identification unit.

22. Door according to one claim 1, further comprising a pair of longitudinal elements, which are arranged in the door at a vertical side away from the hinge and at a vertical side facing the hinge, and a pair of transverse elements which join together the vertical elements by means of pieces of the transverse elements and the longitudinal elements, which are complementary in shape to each other, wherein the complementary piece of the longitudinal elements, looking in a direction of the door essentially parallel to the transverse elements, is present only along a portion of the longitudinal elements, so that an assemblage of the longitudinal elements and the transverse elements looking in the direction of the door essentially parallel to the transverse elements consists of the longitudinal elements in the outermost region.

23. Door according to claim 21, wherein space at least partly enclosed by an assemblage of the longitudinal elements and the transverse is at least partly filled with a Phenol foam.

24. Door according to claim 21, wherein an outer surface of the door comprises a panel which at least partly covers the assemblage of the longitudinal elements and the transverse elements, and the panel is lined with a high-pressure laminate on its exposed surface.

25. Door according to claim 1, wherein the door furthermore contains at least one additional electrical unit built into the door, comprising one or more of a group comprising a proximity detector, a fire detector, a smoke detector, a breath detector, a lighting unit as well as a light emitting diode LED, and a monitor screen, such as a liquid crystal display LCD or a plasma screen.

26. Door according to claim 1, wherein the identification unit comprises a biometric identification unit.

27. Door body for a door according to claim 1, further comprising a cavity which is open toward one end side for arranging therein an insert unit containing at least one of the identification unit, the electrical lock, the power supply unit, and a communication unit, while the door has at least one additional cavity for the arranging therein of an additional insert unit containing at least one of the identification unit, the electrical lock, the power supply unit and the communication unit, while the cavity is made in one end side away from the hinge of the door, and the other cavity is made in an end side of the door facing the hinge.

28. Door body according to claim 27, further comprising a cable lead-through extending from the cavity to the additional cavity, and preferably a wiring is arranged in the cable lead-through.
